(19) United States
(12) Patent Application Publication
(10) Pub. No.: US 2025/0138275 A1
(43) Pub. Date: May 1, 2025

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Wei-Jhe SHEN, Taoyuan City (TW); Sin-Jhong SONG, Taoyuan City (TW); Shou-Jen LIU, Taoyuan City (TW); Kun-Shih LIN, Taoyuan City (TW)

(21) Appl. No.: 18/926,495

(22) Filed: Oct. 25, 2024

Related U.S. Application Data
(60) Provisional application No. 63/593,347, filed on Oct. 26, 2023.

(51) Int. Cl. G02B 7/09

(52) U.S. Cl. CPC G02B 7/09

(57) ABSTRACT

An optical element driving mechanism is provided. The optical element driving mechanism includes a movable part, a fixed part, and a driving assembly. The movable part connects an optical element. The movable part may move relative to the fixed part. The driving assembly drives the movable part to move relative to the fixed part.

### CROSS REFERENCE TO RELATED APPLICATIONS

This application claims the benefit of U.S. Provisional Application No. 63/593,347, filed 2023 Oct. 26, the entirety of which is incorporated by reference herein.

### BACKGROUND OF THE INVENTION

### Field of the Invention

The present invention relates to an optical element driving mechanism, and, in particular, it relates to an optical element driving mechanism that includes a driving assembly, which includes multiple magnetic elements, protecting elements, and coils.

### Description of the Related Art

With the advancement of technology, many electronic devices today (such as laptops, smartphones, and digital cameras) are equipped with photographic or video recording functions. The use of these electronic devices is becoming increasingly common, and there is a trend toward developing more stability and better optical quality, along with convenient and lightweight designs to provide users with more options.

In light of this, there is a need for an optical element driving mechanism that allows for the use of heavier optical elements to accommodate various outdoor photography needs. At the same time, the optical element driving mechanism should reduce operational errors caused by interference with magnetic elements, stabilize the internal structure, and provide more stability and better optical quality.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a movable part, a fixed part, and a driving assembly. The movable part connects an optical element. The movable part may move relative to the fixed part. The driving assembly drives the movable part to move relative to the fixed part

According to certain aspects of the present disclosure, the optical element driving mechanism further comprises a positioning assembly, wherein the driving assembly includes a coil and a magnetic element, and the positioning assembly positions the coil. The positioning assembly includes a side wall, positioning the coil.

According to certain aspects of the present disclosure, the side wall includes a first surface, and a second surface. The first surface faces the coil. The second surface faces the magnetic element.

According to certain aspects of the present disclosure, the second surface is not parallel to the first surface.

According to certain aspects of the present disclosure, the first surface has a first axis, parallel to the first surface, wherein along the first axis, the shortest distance between the coil and the magnetic element is greater than the shortest distance between the second surface and the magnetic element.

According to certain aspects of the present disclosure, the positioning assembly further includes a support part, fixedly connected to the side wall. Along the first axis, the maximum dimension of the support part is greater than the maximum dimension of the side wall.

According to certain aspects of the present disclosure, the second surface has a second axis, parallel to the second surface, the second axis is perpendicular to the first axis. Along the second surface, the maximum dimension of the support part is greater than the maximum dimension of the side wall.

According to certain aspects of the present disclosure, when observed along the second axis, the coil comprises a first portion; and a second portion. The first portion is closer to the support part than the second portion. Along the first axis, the shortest distance between the first portion and the magnetic element is different from the shortest distance between the second portion and the magnetic element.

According to certain aspects of the present disclosure, along the first axis, the shortest distance between the first portion and the magnetic element is greater than the shortest distance between the second portion and the magnetic element.

According to certain aspects of the present disclosure, along the first axis, the shortest distance between the second portion and the magnetic element and the shortest distance between the first portion and the magnetic element has a difference value, the difference value is at least 0.008 mm.

According to certain aspects of the present disclosure, the coil is made of a lead wire, and the difference value is greater than the dimension of the cross-section of the lead wire.

According to certain aspects of the present disclosure, the optical element driving mechanism further includes a circuit assembly, electrically connected to the driving assembly. The circuit assembly is at least partially disposed on the support part.

According to certain aspects of the present disclosure, the circuit assembly includes a first connecting part and a second connecting part. The first connecting part corresponds to an external circuit. The second connecting part corresponds to the driving assembly. Along the second axis, the center of the movable part is located between the first connecting part and the second connecting part.

According to certain aspects of the present disclosure, the optical element driving mechanism further includes a first connecting element. The coil is connected to the positioning assembly via the first connecting element. The first connecting element is in direct contact with the first surface and the support part.

According to certain aspects of the present disclosure, the first connecting element does not contact the second surface.

According to certain aspects of the present disclosure, the optical element driving mechanism further includes a protecting assembly and a second connecting element. The protecting assembly corresponds to the driving assembly.

According to certain aspects of the present disclosure, the side wall further includes a third surface, and the protecting assembly includes a protecting element, the protecting element is disposed on the third surface. The direction in which the third surface is facing is different from the first surface and the second surface.

According to certain aspects of the present disclosure, the second connecting element is in direct contact with the protecting element, the coil, and the third surface.

According to certain aspects of the present disclosure, the optical element driving mechanism further includes a guiding assembly. The movable part moves relative to the fixed part via the guiding assembly. The guiding assembly includes a guiding element and a corresponding part. The guiding element is disposed on the support part. The corresponding part corresponds to the guiding element. The corresponding part moves relative to the guiding element.

According to certain aspects of the present disclosure, the optical element driving mechanism further includes a sensing assembly for sensing the movement of the movable part. The sensing assembly is at least partially disposed on the support part. The guiding element and the sensing assembly are disposed on different surfaces of the support part, wherein these surfaces face different directions

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a front perspective view of the optical element driving mechanism, according to certain aspects of the present disclosure.

FIG. 2 is an exploded perspective view of the optical element driving mechanism, according to certain aspects of the present disclosure.

FIG. 3 is a front perspective view of the positioning assembly of the optical element driving mechanism, according to certain aspects of the present disclosure.

FIG. 4 is a partial cross-sectional enlarged view of the optical element driving mechanism along line A-A of FIG. 1, wherein the fixed part is removed for illustrative purposes.

FIG. 5 is a partial enlarged top view of the optical element driving mechanism, according to certain aspects of the present disclosure, wherein the fixed part is removed for illustrative purposes, and the movable part and positioning assembly are shown in dashed lines.

FIG. 6 is a top view of the optical element driving mechanism, according to certain aspects of the present disclosure, wherein the fixed part is removed for illustrative purposes, and the movable part and positioning assembly are shown in dashed lines.

FIG. 7A is a schematic view of the first connecting element of the optical element driving mechanism, according to certain aspects of the present disclosure, wherein the fixed part is removed for illustrative purposes, and the coil and the protecting assembly are shown in dashed lines.

FIG. 7B is a schematic view of the second connecting element of the optical element driving mechanism, according to certain aspects of the present disclosure, wherein the fixed part is removed for illustrative purposes, and the coil and protecting assembly are shown in dashed lines.

### DETAILED DESCRIPTION OF THE INVENTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features may be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The present disclosure relates to an optical element driving mechanism, which has a driving assembly that includes a coil and magnetic elements to drive the movable part and optical element, thereby adjusting the imaging of the optical element driving mechanism.

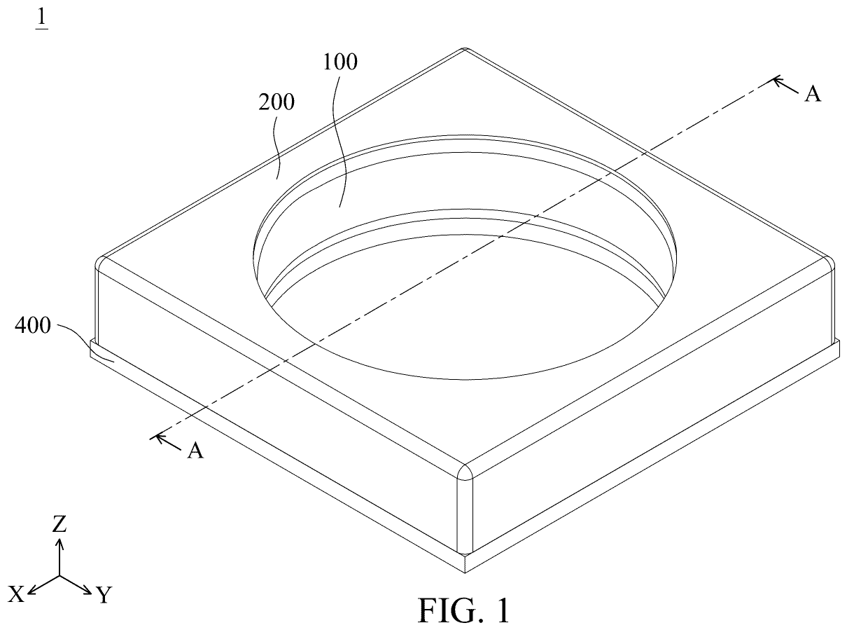

First, please refer to FIG. 1. FIG. 1 is a front perspective view of the optical element driving mechanism 1, according to certain aspects of the present disclosure.

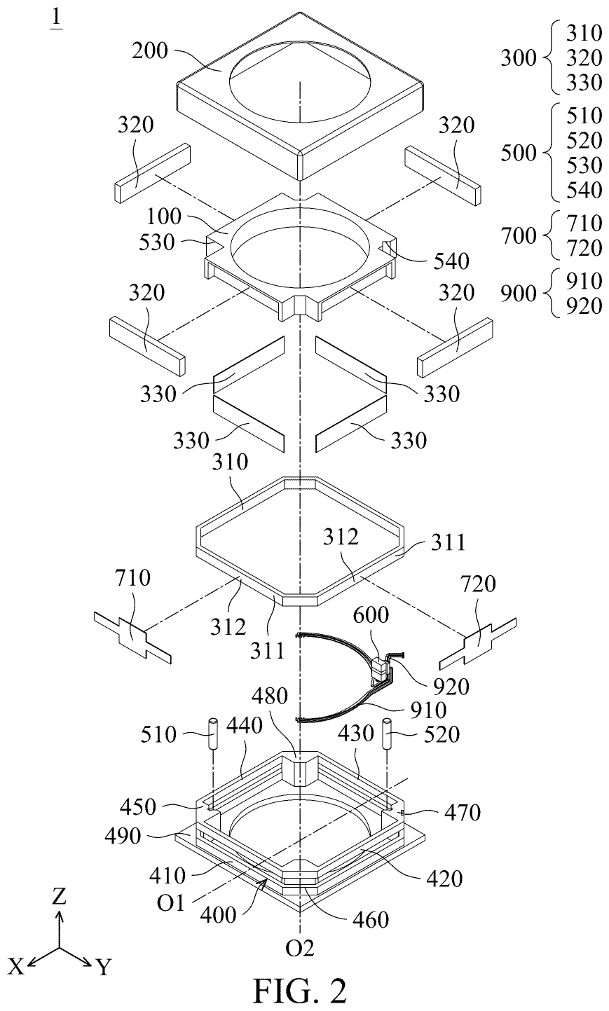

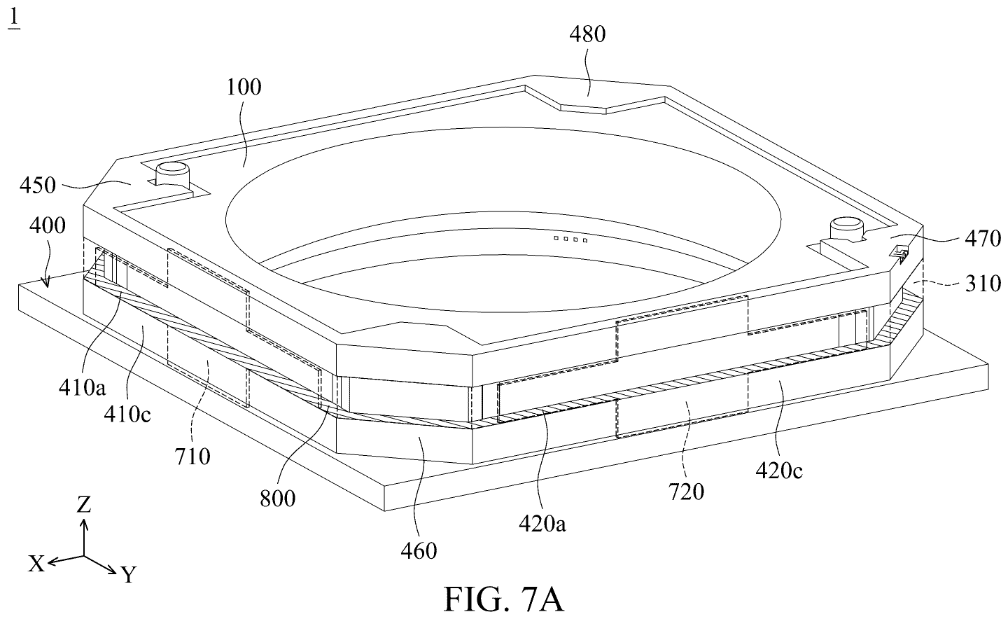

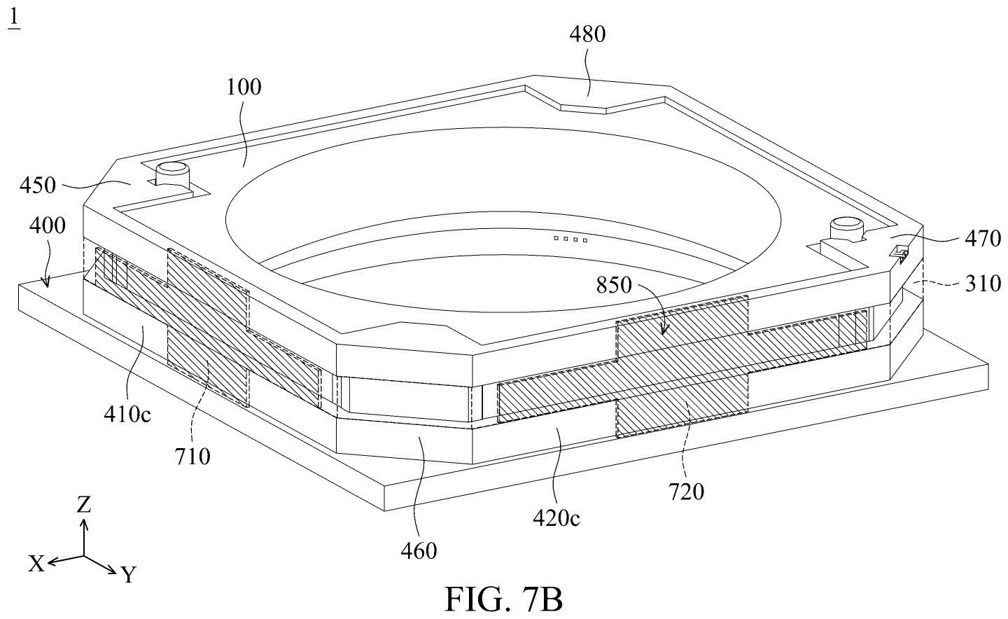

Refer to FIG. 2 next. FIG. 2 is an exploded perspective view of the optical element driving mechanism 1, according to certain aspects of the present disclosure. The optical element driving mechanism 1 includes an movable part 100, a fixed part 200, a driving assembly 300, a positioning assembly 400, a guiding assembly 500, a sensing assembly 600, a protecting assembly 700, a first connecting element 800 (shown in FIG. 7B), a second connecting element 850 (shown in FIG. 7B), and a circuit assembly 900.

The movable part 100 connects an optical element (not shown), which may be, for example, an optical lens. The movable part 100 may move relative to the fixed part 200, and the driving assembly 300 drives the movable part 100 to move relative to the fixed part 200. The positioning assembly 400 is fixedly connected to the fixed part 200. The protecting assembly 700 corresponds to the driving assembly 300. The movable part 100 may move relative to the fixed part 200 via the guiding assembly 500. The sensing assembly 600 senses the movement of the movable part 100. The circuit assembly 900 is electrically connected to the driving assembly 300.

The driving assembly 300 includes a coil 310, a plurality of magnetic elements 320, and a plurality of magnetically permeable plates 330. In this embodiment, the driving assembly 300 includes four magnetic elements 320 and four magnetically permeable plates 330. The coil 310 is fixedly positioned at the positioning assembly 400. The magnetic elements 320 are fixedly positioned on the movable part 100.

By the electromagnetic driving force generated between the magnetic elements 320 and the coil 310, the magnetic elements 320 move relative to the coil 310, thereby driving the movable part 100 to move relative to the positioning assembly 400. Thus, the electromagnetic driving force generated between the magnetic elements 320 and the coil 310 may drive the movable part 100 to move relative to the fixed part 200.

The four magnetically permeable plates 330 are fixedly connected to the magnetic elements 320 of the driving assembly 300 to prevent magnetic field interference between multiple magnetic elements 320.

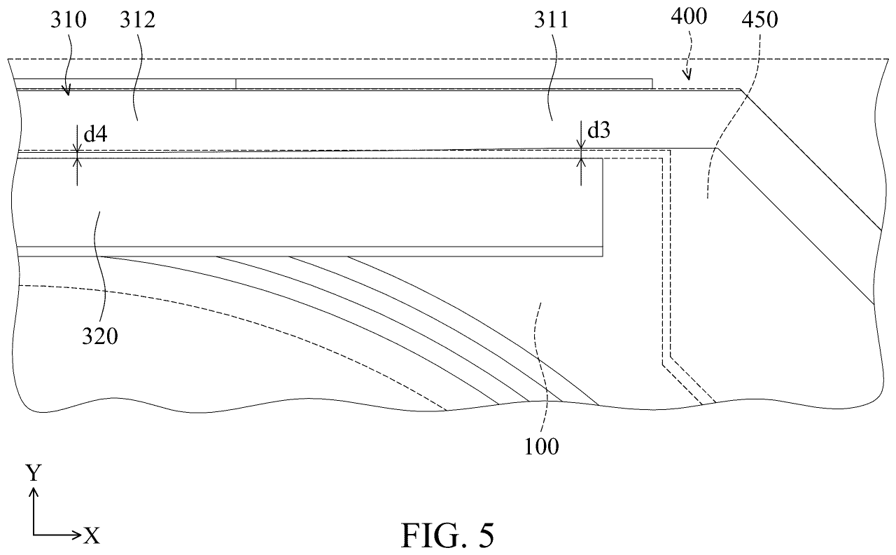

The coil 310 includes a plurality of first portions 311 and a plurality of second portions 312. Both the first portion 311 and the second portion 312 are located on the same side of the coil 310. The first portion 311 is closer to the support part 450 of the positioning assembly 400 than the second portion 312. The first portion 311 and the second portion 312 will be described in more detail relative to FIG. 5 below.

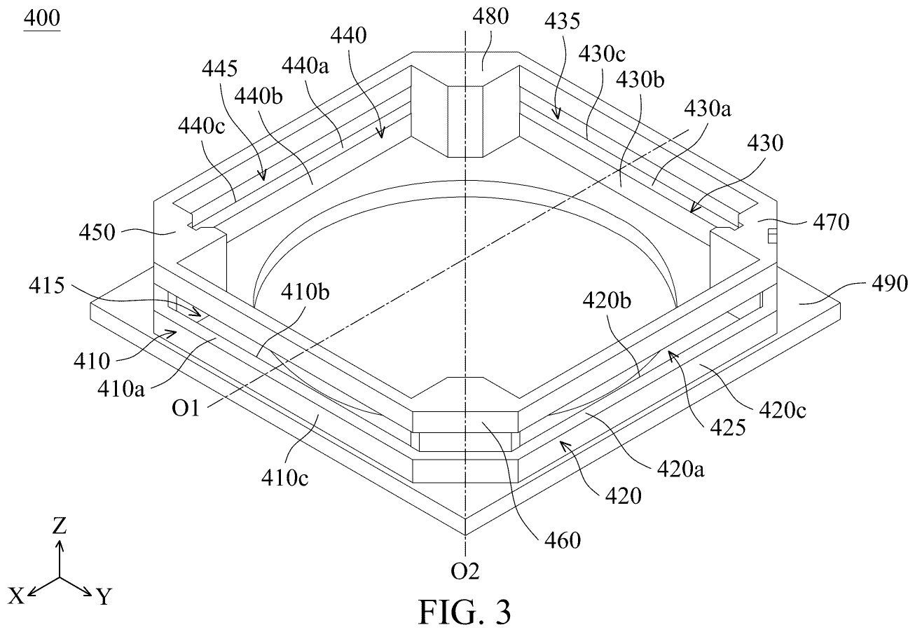

The positioning assembly 400 positions the coil 310. The positioning assembly 400 includes a plurality of side walls 410, 420, 430, 440, a plurality of hollow sections 415, 425, 435, 445 (see FIG. 3), a plurality of support parts 450, 460, 470, 480, a base plate 490, a first axis O1, and a second axis O2. The coil 310 is positioned at the side walls 410, 420, 430, 440. The support parts 450, 460, 470, 480 are fixedly connected to the side walls 410, 420, 430, 440. The side walls 410, 420, 430, 440 are fixedly positioned and connected to the base plate 490. The second axis O2 is perpendicular to the first axis O1.

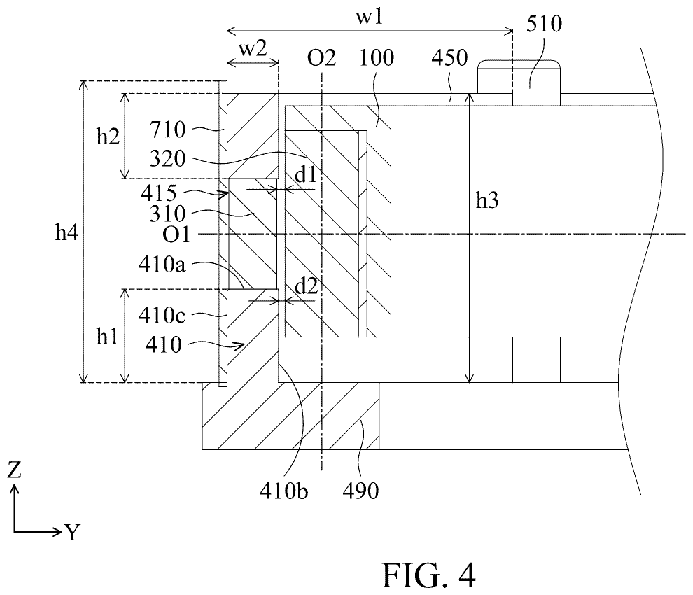

Next, please refer to FIG. 2, FIG. 3, and FIG. 4 together. FIG. 3 is a front perspective view of the positioning assembly 400 of the optical element driving mechanism 1, according to certain aspects of the present disclosure. FIG. 4 is a partial cross-sectional enlarged view of the optical element driving mechanism 1 along line A-A of FIG. 1, wherein the fixed part is removed for illustrative purposes. FIG. 4 only shows one set of side wall 410 and support part 450; other sets of side walls and support parts may also have the features as described below.

The side walls 410, 420, 430, and 440 each have a first surface 410a, 420a, 430a, 440a, a second surface 410b, 420b, 430b, 440b, and a third surface 410c, 420c, 430c, 440c (FIG. 4 shows only the first surface 410a, the second surface 410b, and the third surface 410c).

The first surfaces 410a, 420a, 430a, and 440a face the coil 310, while the second surfaces 410b, 420b, 430b, and 440b face the magnetic elements 320. The second surfaces 410b, 420b, 430b, and 440b are not parallel to their respective first surfaces 410a, 420a, 430a, and 440a. The third surfaces 410c, 420c, 430c, and 440c face in a direction different from that of their respective first surfaces 410a, 420a, 430a, 440a and second surfaces 410b, 420b, 430b, 440b.

The first axis O1 is parallel to the first surface 410a. Along the first axis O1, the shortest distance d1 between the coil 310 and the magnetic element 320 is greater than the shortest distance d2 between the second surface 410b and the magnetic element 320. This means that the second surface 410b is closer to the magnetic element 320 than the coil 310. Along the first axis O1, the maximum dimension w1 of the support part 450 is greater than the maximum dimension w2 of the side wall 410.

The second axis O2 is parallel to the second surface 410b. The side walls 410, 420, 430, and 440 each have two parts. The two parts of the side walls 410, 420, 430, and 440 have heights h1 and h2. Between the two parts are the hollow sections 415, 425, 435, and 445 (see FIG. 3), to accommodate the coil 310. FIG. 4 shows the hollow section 415 between the two parts of the side wall 410 accommodating the coil 310.

The support part 450 has a height h3. Along the second axis O2, the height h3 is approximately equal to the sum of the two heights h1 and h2 of the side wall 410 and the height of the hollow section. Therefore, the sum of the two heights h1 and h2 of the side wall 410 is less than the height h3 of the support part 450. The maximum height h3 of the support part 450 is greater than the maximum dimension of the sum of the two heights h1 and h2 of the two parts of the side wall 410.

Next, please refer to FIG. 5. FIG. 5 is a partially enlarged top view of the optical element driving mechanism 1, according to certain aspects of the present disclosure, wherein the fixed part 200 is removed for illustrative purposes, and the movable part 100 and positioning assembly 400 are shown in dashed lines. FIG. 5 shows only one set of the first portion 311, the second portion 312, and the magnetic element 320. Other first portions 311, second portions 312, and magnetic elements 320 may also have the features described below.

Observing along a second axis O2 of the positioning assembly 400, the first portion 311 of the coil 310 is closer to the support part 450 than the second portion 312.

Along the first axis O1, the shortest distance d3 between the first portion 311 and the magnetic elements 320 is greater than the shortest distance d4 between the second portion 312 and the magnetic elements 320. The shortest distances d3 and d4 have a difference value that is at least 0.008 millimeters. This difference value is greater than the dimension of the cross-section of the lead wire forming the coil 310.

Next, please continue to refer to FIG. 2. The guiding assembly 500 includes a plurality of guiding elements 510, 520, and respective corresponding parts 530, 540. The guiding elements 510 and 520 are disposed on the support parts 450 and 470. The corresponding parts 530 and 540 are formed on the movable part 100. The corresponding parts 530 and 540 correspond to the guiding elements 510 and 520, and may move relative to the guiding elements 510 and 520.

In this embodiment, the corresponding part 530 has a flat surface, while the corresponding part 540 has a V-shaped groove, each contacting with the guiding elements 510 and 520. The corresponding parts 530, 540 may be any suitable shape for the guiding elements 510 and 520.

When the magnetic elements 320 move relative to the coil 310, driving the movable part 100 to move relative to the positioning assembly 400, the guiding elements 510 and 520 stabilize the movement and prevent tipping.

The sensing assembly 600 is at least partially positioned on the support part 470. The guiding element 520 and the sensing assembly 600 are disposed on different surfaces of the support part 470, with these surfaces facing different directions.

The protecting assembly 700 includes a plurality of protecting elements 710 and 720. The protecting elements 710 and 720 are positioned on the third surfaces 410c and 420c. The height h4 of the protecting elements 710 and 720 is greater than the movement range of the movable part 100. The height h4 of the protecting elements 710 and 720 is greater than the height h3 of the support part 450 (see FIG. 4). The protecting elements 710 and 720 may be magnetically permeable plates. In this embodiment, the protecting elements 710 and 720 are approximately cross-shaped, but in other embodiments, they may be any shape that effectively prevents magnetic interference during the movement of the movable part 100.

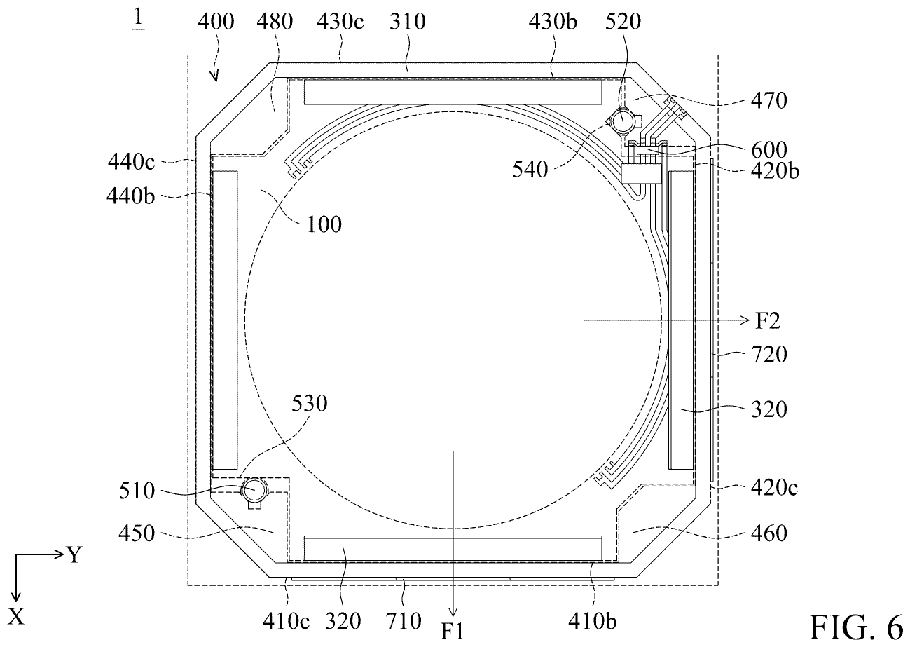

Next, please refer to FIG. 6. FIG. 6 is an enlarged top view of the optical element driving mechanism 1, according to certain aspects of the present disclosure, with the fixed part 200 removed for illustrative purposes and the movable part 100 and positioning assembly 400 shown in dashed lines.

The protecting elements 710 and 720 are located on the third surfaces 410c and 420c, with the magnetic attraction forces F1 and F2 drawing the movable part 100 towards the protecting elements 710 and 720. This arrangement ensures that the guiding elements 510 and 520 lean against the corresponding parts 530 and 540 disposed on the support parts 450 and 470.

Therefore, the protecting elements 710 and 720 may prevent magnetic interference during the movement of the movable part 100, while also stabilizing the movement of the movable part 100 through the contact between the guiding elements 510 and 520 and the corresponding parts 530 and 540.

Next, please refer to FIG. 3 and FIG. 7A together. FIG. 7A is a schematic view of the first connecting element 800 of the optical element driving mechanism 1, according to certain aspects of the present disclosure, wherein the fixed part 200 is removed for illustrative purposes, and the coil 310 and the protecting assembly 700 are shown in dashed lines.

The hatched area in FIG. 7A shows the distribution area of the first connecting element 800. The coil 310 may be connected to the positioning assembly 400 via the first connecting element 800. The first connecting element 800 is in direct contact with the first surfaces 410a, 420a, 430a, and 440a, as well as the support parts 450, 460, 470, and 480. The first connecting element 800 does not contact the second surfaces 410b, 420b, 430b, and 440b, only making contact with the first surfaces.

Next, please refer to FIG. 3 and FIG. 7B together. FIG. 7B is a schematic view of the second connecting element 850 of the optical element driving mechanism 1, according to certain aspects of the present disclosure, wherein the fixed part 200 is removed for illustrative purposes, and the coil 310 and protecting assembly 700 are shown in dashed lines.

The hatched area in FIG. 7B shows the area of the second connecting element 850. The protecting elements 710 and 720 may connect the coil 310 to the third surfaces 410c, 420c, 430c, and 440c via the second connecting element 850. The second connecting element 850 is in direct contact with the protecting elements 710 and 720, the coil 310, and the third surfaces 410c, 420c, 430c, and 440c. The first connecting element 800 and the second connecting element 850 may be connecting materials such as adhesives.

Next, please refer to FIG. 2. The circuit assembly 900 is at least partially positioned on the support part 470. The circuit assembly 900 includes a first connecting part 910 and a second connecting part 920. The first connecting part 910 may correspond to an external circuit (not shown). The second connecting part 920 connects the coil 310 of the driving assembly 300 and may be electrically connected to the leads of the coil 310. Along the second axis O2, the center of the movable part 100 is positioned between the first connecting part 910 and the second connecting part 920. In other words, one of the connecting parts 910 and 920 is located above the center of the movable part 100, while the other is located below it. In this embodiment, the first connecting part 910 is positioned below the movable part 100, while the second connecting part 920 extends above the movable part 100. Furthermore, when viewed along the first axis O1, the coil 310 is disposed between the first connecting part 910 and the second connecting part 920. When viewed along the second axis O2, the first connecting part 910 does not overlap the coil 310, while the second connecting part 920 overlaps the coil 310 at least partially. However, other embodiments may have different configurations.

In summary, the present invention provides an optical element driving mechanism that includes an movable part, a fixed part, a driving assembly, a position sensing assembly, and circuit assembly. The movement of the driving assembly drives the movable part to move relative to the fixed part, allowing for adjustments to the position of the optical element to achieve different photographic imaging. Additionally, the coil and magnetic elements of the driving assembly provide the driving force. The protecting assembly stabilize the internal structure and reduce operational errors.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments may be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, comprising:
a movable part, for connecting an optical element;
a fixed part, wherein the movable part may move relative to the fixed part; and
a driving assembly, wherein the driving assembly drives the movable part to move relative to the fixed part.

2. The optical element driving mechanism as claimed in claim 1, further comprising a positioning assembly, wherein the driving assembly includes a coil and a magnetic element, and the positioning assembly positions the coil.

3. The optical element driving mechanism as claimed in claim 2, wherein the positioning assembly includes:
a side wall, positioning the coil, wherein the side wall includes:
a first surface facing the coil; and
a second surface facing the magnetic element.

4. The optical element driving mechanism as claimed in claim 3, wherein the second surface is not parallel to the first surface.

5. The optical element driving mechanism as claimed in claim 3, wherein the first surface has a first axis, parallel to the first surface, wherein:
along the first axis, the shortest distance between the coil and the magnetic element is greater than the shortest distance between the second surface and the magnetic element.

6. The optical element driving mechanism as claimed in claim 5, wherein the positioning assembly further includes a support part, fixedly connected to the side wall, wherein:
along the first axis, the maximum dimension of the support part is greater than the maximum dimension of the side wall.

7. The optical element driving mechanism as claimed in claim 6, wherein the second surface has a second axis, parallel to the second surface, and the second axis is perpendicular to the first axis, wherein:
along the second surface, the maximum dimension of the support part is greater than the maximum dimension of the side wall.

8. The optical element driving mechanism as claimed in claim 7, wherein when observed along the second axis, the coil comprises:
a first portion; and
a second portion, wherein the first portion is closer to the support part than the second portion; wherein
along the first axis, the shortest distance between the first portion and the magnetic element is different from the shortest distance between the second portion and the magnetic element.

9. The optical element driving mechanism as claimed in claim 8, wherein along the first axis, the shortest distance between the first portion and the magnetic element is greater than the shortest distance between the second portion and the magnetic element.

10. The optical element driving mechanism as claimed in claim 8, wherein along the first axis, the shortest distance between the second portion and the magnetic element and the shortest distance between the first portion and the magnetic element has a difference value, and the difference value is at least 0.008 mm.

11. The optical element driving mechanism as claimed in claim 10, wherein the coil is made of a lead wire, and the difference value is greater than the dimension of the cross-section of the lead wire.

12. The optical element driving mechanism as claimed in claim 7, further comprising a circuit assembly, electrically connected to the driving assembly, wherein the circuit assembly is at least partially disposed on the support part.

13. The optical element driving mechanism as claimed in claim 12, wherein the circuit assembly comprises:
a first connecting part, corresponding to an external circuit; and
a second connecting part, corresponding to the driving assembly; wherein
along the second axis, the center of the movable part is located between the first connecting part and the second connecting part.

14. The optical element driving mechanism as claimed in claim 6, further comprising:
a first connecting element, wherein the coil is connected to the positioning assembly via the first connecting element; and
the first connecting element is in direct contact with the first surface and the support part.

15. The optical element driving mechanism as claimed in claim 14, wherein the first connecting element does not contact the second surface.

16. The optical element driving mechanism as claimed in claim 14, further comprising a protecting assembly and a second connecting element, wherein the protecting assembly corresponds to the driving assembly.

17. The optical element driving mechanism as claimed in claim 16, wherein:
the side wall further includes a third surface, the protecting assembly includes a protecting element, and the protecting element is disposed on the third surface; and
the direction in which the third surface is facing is different from the first surface and the second surface.

18. The optical element driving mechanism as claimed in claim 17, wherein the second connecting element is in direct contact with the protecting element, the coil, and the third surface.

19. The optical element driving mechanism as claimed in claim 6, further comprising a guiding assembly, wherein the movable part moves relative to the fixed part via the guiding assembly, and the guiding assembly includes:
a guiding element, disposed on the support part; and
a corresponding part, corresponding to the guiding element, wherein the corresponding part moves relative to the guiding element.

20. The optical element driving mechanism as claimed in claim 19, further comprising a sensing assembly for sensing the movement of the movable part, wherein:
the sensing assembly is at least partially disposed on the support part; and
the guiding element and the sensing assembly are disposed on different surfaces of the support part, wherein these surfaces face different directions.
